(19) United States
(12) Patent Application Publication
(10) Pub. No.: US 2009/0103822 A1
(43) Pub. Date: Apr. 23, 2009

(54) METHOD FOR COMPRESSION OF IMAGE DATA

(76) Inventors: Lutz Guendel, Erlangen (DE); Jeffrey P. Johnson, Lawrenceville, NJ (US)

Correspondence Address: SCHIFF HARDIN, LLP;PATENT DEPARTMENT, 6600 SEARS TOWER, CHICAGO, IL, 60606-6473, US

(21) Appl. No.: 11/874,991

(22) Filed: Oct. 19, 2007

(51) Int. Cl. G06K 9/46

(52) U.S. Cl. 382/244

(57) ABSTRACT

In a method and device for compression of image data, in particular medical image data, the image data are initially compressed by means of a lossy compression method with a predetermined starting compression factor. The compressed image data are then analyzed to determine a quality value relative to a defined quality measure and the quality value is compared with a desired quality value predetermined relative to a defined quality measure. A new compression of the image data or further compression of the image data already compressed in a preceding step then ensues with a different compression factor and/or with a different compression method when the quality value deviates by a specific degree from the desired quality value.

### BACKGROUND OF THE INVENTION

1. Field of the Invention

The present invention concerns a method for compression of image data, in particular medical image data, and a method for storage and/or transfer of image data, of the type wherein the image data are compressed in advance with such a method. The invention also concerns an image data compression device for compression of image data.

2. Description of the Prior Art

Imaging systems today assume an important role in nearly all technical fields. In many systems ever greater quantities of image data that are to be transferred to various points (depending on the application field and/or are to be stored in archives for later use or long-term storage are produced for various reasons (such as, for example, the ever greater resolution of digital image sensors and faster processor technologies). This applies to a particular degree for the medical technology field in which imaging systems become ever more important in the examination of patients. The depictions of the internal organs and structures of the patient that are generated by the imaging systems are used for diagnosis of causes of illness, for planning of operations, in the implementation of operations, and for preparation of therapeutic measures. Examples for such imaging systems are “simple” x-ray systems, computed tomography apparatus, ultrasound systems, angiography devices, positron emission tomography apparatus and magnetic resonance systems.

Despite the sharp price decrease of storage systems, the total costs in the operation of such imaging systems rise dramatically due to the increasing data quantity. The problem of data transport over the available networks as well as the further handling of the data are additionally aggravated with the larger data sets. Image data compression is therefore of great interest, but in some fields (such as, for example, in the medical technology field care must be taken so that the data compression does not lead to an adulteration of relevant information.

Two different strategies for reduction of the data storage costs are presently used in the medical technology field.

In a first strategy the diagnosis is implemented on the basis of medical image data with high resolution. The image data are not then stored in an archive, but instead only data sets with lower resolution are stored, which require a significantly lower storage space. A disadvantage of this method is that, under certain circumstances, a later verification of the diagnosis by other persons is no longer possible without further measures.

In a second strategy the reconstructed images are compressed as much as possible by reduction of redundancies. With lossless compression methods, however, the high resolution medical image data can be reduced only by at maximum a factor of 10. Higher reduction rates are presently possible only with lossy compression methods. For example, the known JPEG methods (JPEG=Joint Photographic Experts Group) that can be used, for example, for static images and three-dimensional volumes, and the MPEG methods (MPEG=Moving Pictures Experts Group) such as the MP4 method used for moving images (i.e. films) and the MP3 method used for audio data, are to the typical lossy methods. In the medical technology field a JPEG variant with the designation JPEG2000 is available for four-dimensional signals within the DICOM standard (DICOM=Digital Imaging and Communications in Medicine). Lossy methods unfortunately unavoidably result in a reduction of the image quality such as, for example, a limitation of the resolution or of a color space limitation. In many of the cited compression methods (such as, for example, in JPEG) the compression rates can be adjusted. The greater the compression rate, the greater the information losses as well, and thus also the greater the reduction of the quality. Lossy methods therefore have been little used in the medical technology field. Various compression methods and the image qualities that can be achieved with them are compared in the market study “Compression technologies” by Frost and Sullivan, Dec. 31, 2005.

In order to improve the possibilities for data reduction in the medical technology field, a method is proposed in U.S. Pat. No. 6,912,317 wherein various descriptive data that specify the imaging modalities, the anatomy or other visible features in the reconstructed images, as well as the image matrix size and other image parameters, are entered into the header of a DICOM image data file. The image files are analyzed and an optimal compression algorithm for the present image data is selected based on such descriptive data. The image data are then compressed using this selected algorithm. In order to ensure that the image data are optimally compressed, however, this method requires an optimally correct specification of all relevant factors in the form of the descriptive data in the data header.

### SUMMARY OF THE INVENTION

An object of the present invention is to provide a method for compression of image data as well as a corresponding image data compression device suitable for compressing medical image data.

This object is achieved by a method according to the invention as well as an image data compression device wherein:

(a) compression of the image data by means of a lossy compression method with a predetermined starting compression factor ensues first;

(b) the image data compressed in this manner are then analyzed to determine a quality value relative to a defined quality measure;

(c) comparison of the quality value with a desired quality value predetermined relative to a defined quality measure subsequently ensues; and

(d) a new compression of the original image data or a further compression of the image data already compressed in a preceding step then ensues with a different compression method and/or with a different compression factor when the quality value deviates by a specific degree from the desired quality value.

For example, a lower compression factor can be used when the determined quality value lies below the desired quality value and a higher compression factor can be used when the desired quality value is better than the desired quality value.

This method is implemented until the achieved quality value lies close enough to the desired quality value. For example, the compression factor is increased ever further so that the determined quality value approaches ever closer to the desired quality value and ultimately lies close enough to the desired quality value, i.e. within the determined degree (of deviation). Should it occur in the method that the quality value cannot be achieved, the method can be terminated after a specific number of compression cycles and a corresponding message can be output to the user.

For example, in step (d) a further compression of the image data compressed in the immediately preceding step can ensue if the image quality thereby achieved still lies above the desired quality. If the desired quality value is not satisfied, meaning that the current quality is poorer than the desired quality, either the original image data can be used, or the image data compressed in a further preceding step in which the quality measure was still achieved can be used. A new attempt with the original image data is likewise reasonable when a change of the compression method should be implemented.

Various compression methods can be used in this method, among others the compression algorithms described above or the compression algorithms described in the specified literature passages. The methods are advantageously used in which it is possible to predetermine an arbitrary compression factor, such as, for example, the cited JPEG and MPEG methods.

Using this method, by specification of a determined quality measure and by the specification of a desired quality value with regard to this quality measure it can be ensured that a maximum compression of image data is achieved, with a specific desired quality always being maintained.

The inventive method is preferably used in the storage and/or transfer of image data in order to ensure that the effective data quantity to be stored or to be transferred is optimally low.

An inventive image data compression device includes the following components:
an image data interface for receiving image data;
a storage unit and/or an interface for specification of starting compression factors, quality measures and/or desired quality values. The interface also can be a user interface such that an operator of the device can directly predetermine the starting compression factor, the quality measure or, respectively, the desired quality value;

This can also be a network interface in order to automatically adopt these data from other units. It is in particular also possible that a portion of the data (for example the quality measure and a starting compression factor) is permanently stored in a memory unit of the image data compression device and, for example, only a desired quality value relative to this quality measure is still to be input via the interface. In a preferred embodiment variant various quality measures are stored in the storage unit and one of the quality measures must only be selected by the user via an interface. A starting compression factor stored with regard to this quality measure is then used. The desired quality value is input again by the user.
an image data calculation unit for compression of image data by means of a lossy compression method (algorithm) with a predetermined compression factor. The compression algorithm, for example, can be stored in a storage unit of the image data compression device. Alternatively, a number of compression algorithms can be stored and the user can select a specific compression method as the starting compression method via an interface;
an image analysis unit for analysis of compressed image data for determination of a quality value with regard to a predetermined quality measure;
a comparison unit for comparison of the quality value with a desired quality value predetermined relative to the defined quality measure; and
a control unit for controlling the image data calculation unit in order to implement a new compression of image data or further compressions of the image data already compressed in a preceding step with a different compression method and/or with a changed compression factor when the quality value deviates from the desired quality value by a specific measure.

A large part of the aforementioned components of the image data compression device can be realized wholly or in part as software modules in the processor of a computer. This is advantageous since already present image processing devices (such as, for example, control computers at tomography systems, diagnostic devices, etc.) can also be retrofitted for implementation of the inventive method by a simple software installation. The invention therefore also encompasses a computer program product which can be loaded directly into a processor of a programmable image data compression device and which has a program code. (data structure) that implements all steps of the aforementioned method when the program is executed in the image data compression device.

There are various possibilities for the definition of the quality measure and the quality value to be determined on the basis of the quality measure.

For example, the signal-to-noise ratio (SNR) can be used as the quality measure. A quality value Q_{SNR} based on this quality measure can then be calculated from the compressed image data and the uncompressed image data as follows:

$${Q}_{SNR} = 10 \cdot log \frac{\sum {D}_{U}^{2}}{\sum {( {D}_{U} - {D}_{C} )}^{2}} \qquad ( 1 )$$

wherein D_{U} is the signal amplitude of the uncompressed data and D_{C} is the signal amplitude of the compressed data. The dividend thus corresponds to the signal rating of the uncompressed data and the divisor corresponds to the error rating. The summation ensues across all pixels of the image.

Alternatively, other mathematical error methods are possible, such as correlation measurements of the compressed and uncompressed data or error methods based on frequency or wavelet analysis.

Further possible preferred quality measures are based on the use of a psychological (in particular psychophysical) criterion of human visual perception. For medical technology image data this can be have the advantage that the most important point is taken into account in the compression method, namely to what extent a person who must possibly assess the images again is influenced by an inadequate image quality.

A simple quality measure that takes into account psychophysical factors is known as the “differential perceptibility threshold”, which is also designated as a “JND value” (JND=Just Noticeable Difference=smallest perceivable difference). A lower JND value is thereby associated with a better image quality. Higher JND values are an indication of a higher compression error. For example, an average JND value can be calculated across the entire image. This can then be compared with a desired JND value in order to optimally set the compression factor with the inventive method.

As in the aforementioned examples, both the quality measure and the quality value can in principle be predetermined globally for an entire image to be compressed.

However, in an alternative variant a quality value can be defined relative to a selected local image region. The quality measure itself can likewise only be locally predetermined. For example, specific image regions can be selected in the images and different local quality measures and/or different quality values can be predetermined, respectively for these regions. For example, in many cases the quality measure is globally predetermined and different quality values are respectively established only for the various selected image regions.

The local image regions can thereby be contiguous image regions. In principle, however, a local image region can include a number also comprise a plurality of non-contiguous but (for example) nevertheless associated partial image regions. Medical technology images in particular are available for defining a specific region of interest (ROI) within the entire image, the region of interest containing the relevant information, for example a specific organ or a sub-region of an organ with a determined defect. It is then sufficient to predetermine the quality measure and/or the desired quality value for this region of interest so that it is ensured that this region is rendered with a specific quality in the compressed images. For the remaining image regions, either no quality value whatsoever can be predetermined or, for example, a significantly worse quality value can be predetermined since these image regions possibly still serve in any case to define the spatial position of the region of interest within the entire image. This is explained below using exemplary images.

Particularly when specific organs or structures are of interest, it is advantageous to establish a specific image region using an image segmentation method. Depending on the embodiment of the method, determined structures (such as, for example, bones, organs etc.) in the image data can be segmented manually, semi-automatically or wholly automatically with such image segmentation methods. Various suitable methods are known to the those skilled in the art. For example, there are various model-based segmentation methods or simple threshold methods that implement segmentation by establishment of a specific threshold and an association of pixels with image regions on the basis of the threshold. Further known methods are of the type known as “region growth methods”.

The operator can select a specific organ in a simple manner. The precise image region in which the image pixels belonging to this organ are located is then established with the aid of the segmentation method. A desired quality value relative to the defined quality measure (for example the SNR value) or relative to the JND value can be established for this organ, such that the compression of the entire image ensues such that the desired quality value is maintained with regard to this organ.

Given such a determination of a quality value for a local region, for example in the case of the SNR quality value Q_{SNR} according to equation (1), a summation can ensue only across all image pixels within the defined local image region. Given other quality measures, a determination of the average quality value could analogously also ensue only over the selected local image region.

In the simplest variants, respective average quality values are thus calculated for the global image or for the locally defined image regions and corresponding average desired quality values are predetermined, meaning that an average quality value is thereby maintained over the respective image region. Alternatively, however, a precise quality value can also be predetermined for every image pixel. This can ensue, for example, in the form of a desired quality value map.

A quality value map that specifies precisely the attained quality value at each image pixel can correspondingly also be generated for an image to be compressed on the basis of the quality measure. For example, for an SNR map the calculation of the SNR values for the individual image pixels can again ensue according to equation (1), whereby a summation is not calculated across the individual image pixels, however, but rather the calculation ensues separately for each image pixel. A separate JND value can likewise be calculated for each image pixel in order to calculate what is known as a JND map. The quality map thus determined in the step (b) of the inventive method can then be compared with a predetermined desired quality map. Specific local image regions in which a specific desired quality value should be achieved at each individual pixel can be specified very simply in the context of such a desired quality value map.

In a further preferred embodiment, compression factors locally different for different image regions are used with the aid of the inventive method. With this it is possible, for example, to achieve a homogeneous quality of the entire image. For example, a quality value map can be determined as a quality value for this and a desired quality value map is predetermined in which the same desired quality value is predetermined for all image pixels. This then automatically causes an image that exhibits a homogeneous quality to be ultimately generated independently of the image information being processed as well as its ability to be compressed.

Furthermore, it is possible to ensure that a homogeneous image quality is achieved only in specific local image regions.

Information about the employed compression method and the compression factor are advantageously linked with the compressed image. For example, such data can be written into the header of the image file, in particular in the DICOM standard. The image data can possibly then be decompressed again with the aid of this information after a transfer and/or storage of the compressed images.

### BRIEF DESCRIPTION OF THE DRAWINGS

FIG. 1 is a flowchart of an embodiment of the inventive method.

FIG. 2 is a schematic block diagram for an exemplary embodiment of an inventive image data compression device.

FIG. 3 is an uncompressed axial image (to the left) through a human body in the region of the pelvis and, for comparison, a compressed image (to the right) generated therefrom.

FIG. 4 is a JND map of a compressed axial cross-section image through the human abdomen.

FIG. 5 is a VRT image of a human abdomen with relatively high quality.

FIG. 6 shows the VRT image according to FIG. 5 in compressed form with lower quality, with only a selected image region being stored with high quality.

FIG. 7 shows an axial image of the human body in the region of the liver with low quality.

FIG. 8 shows the image according to FIG. 7, whereby the image region in which the liver is depicted is stored with higher quality.

### DESCRIPTION OF THE PREFERRED EMBODIMENTS

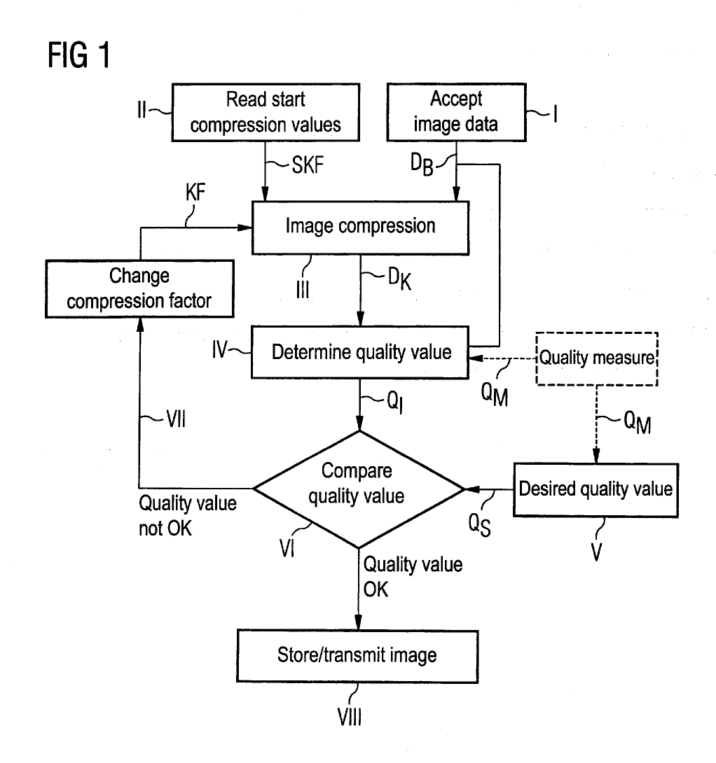

FIG. 1 is an overview of an embodiment of a workflow of the inventive method. In step I the image data D_{B} are initially accepted and in step II a starting compression factor SKF is imported. These two steps can also ensue in another order or in parallel. The image data D_{B} can be accepted from an arbitrary memory in which they are cached but can also be accepted directly from the image reconstruction. In the shown exemplary embodiment it is assumed that only one starting compression factor SKF is predetermined for the entire image. Alternatively, however, different starting compression factors can also be predetermined that should apply for different regions in the image.

In step III the image is then compressed with a first compression method (which is hard-preset here) with the predetermined starting compression factor SKF. Here, for simplicity, it is assumed that a specific compression factor is used that can operate with arbitrary compression values. A preferred embodiment for this is the JPEG2000 method which can serve for compression of two-dimensional, three-dimensional or four-dimensional data and is already implemented in medical technology, for example for two-dimensional data in the DICOM standard. Alternatively, other compression methods can also be used. It is likewise possible that various compression methods are available from which one is selected or manually predetermined automatically as a starting compression method, and within the method not only the compression factor but rather also the compression method can be changed (as is explained below).

After the image has been compressed in step II, a quality value Q_{I} is determined in step IV using the compressed image data D_{K}. For this the originally accepted image data D_{B} are also used. This means that the quality value Q_{I} is determined via a comparison of the original image data D_{B} and the compressed image data D_{K} according to a predetermined quality measure Q_{M}. As explained above using equation (1), such a quality measure can be an SNR calculation. When the calculation of a global SNR value is predetermined as a quality measure, this means that a corresponding average SNR value Q_{SNR} is determined with equation (1) in step IV from the original image data D_{B} and the compressed image data D_{K} and is adopted as a current quality value Q_{I}.

The quality measure Q_{M} can be predetermined in a fixed manner. For example, it can be predetermined at the beginning of the method. A number of possible quality measures Q_{M} can be stored in a memory, such that the operator can select a suitable quality measure Q_{M} (for example at the beginning of or during the compression method). As explained above, different quality measures and, respectively, quality values can be predetermined for the many different image regions.

The quality value Q_{I} so determined is then compared in step VI with a desired quality value Q_{S} predetermined in step V. This desired quality value Q_{S} is likewise defined on the basis of the predetermined quality measure Q_{M}. The specification of this desired quality value Q_{S} can likewise already have occurred at the start of the entire compression method or also during this. As explained above, it is also possible to predetermine various desired quality values Q_{S} for specific regions. The quality measure Q_{M} and the desired quality value Q_{S} then apply for the complete further method workflow.

If it is established in step VI that the quality value Q_{I} lies near enough to the desired quality value Q_{S} (for example does not deviate from this desired quality value Q_{S} by a specific measure or is even identical with this desired quality value Q_{S}), the quality value Q_{I} is considered to be in order and in step VIII the image is stored in the compressed form depending on the specification and/or is transferred to other stations via a network. In contrast to this, if it is established that the quality value Q_{I} is not in order, in step VII the compression factor KF is changed and a new image compression is implemented in step III with the changed compression factor KF. For example, a lower compression factor is used when the determined quality value Q_{I} lies below the desired quality value Q_{S} and a higher compression factor is used when the determined quality value Q_{I} is better than the desired quality value Q_{S}.

The determination of the current weighting vector Q_{I} subsequently ensues again in step IV and the comparison of the current quality value Q_{I} with the desired quality value Q_{S} ensues in step VI. This loop is then run through until a satisfactory quality value Q_{I} is achieved.

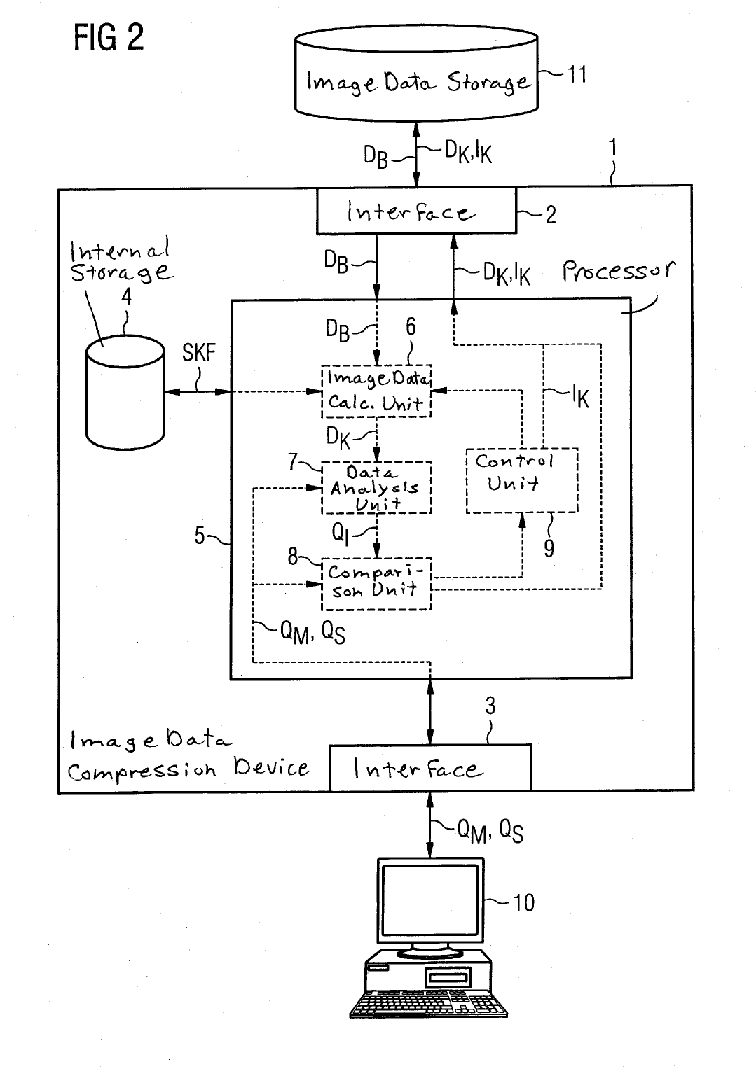

FIG. 2 shows an exemplary embodiment for an inventive image data compression device 1. For example, it can hereby be a finding station on which the high resolution images are initially assessed and then are subsequently compressed for a long-term storage. The image data compression device 1 is connected via a terminal (console) interface 3 to a terminal (console) 10 via which an operator can operate the image data compression device 1.

Moreover, the image data compression device 1 is connected with a storage 11 via an image data interface 2. The image data D_{B} are initially stored in this storage 11 and can be read therefrom. The compressed image data D_{K} can likewise also be stored in this storage 11, possibly together with compression information I_{K} about the compression method and the compression factor as well as further data that are used for a later decompression.

The connection to the storage 11 can also ensue via a network to which, for example, still further components are connected, in particular imaging systems, further workstations and further mass storage. The image data interface 2 can also be a network interface. An example for such a network is an RIS (Radiological Information System).

The image data compression device 1 moreover possesses an internal storage device 4 as well as a processor 5 in which further components 6, 7, 8, 9 are stored in the form of software. The components 6, 7, 8, are an image data calculation unit 6, an image data analysis unit 7 and a comparison unit 8. These units 6, 7, 8 are controlled by a common control unit 9 which is also realized in the form of a software component.

The image data calculation unit 6 serves for compression of image data D_{B} by means of a specific predetermined compression method with a predetermined compression factor.

The image data analysis unit 7 serves for analysis of compressed image data D_{K} for determination of a quality value Q_{I} and the comparison unit 8 serves for comparison of the quality value Q_{I} with a predetermined desired quality value Q_{S}.

The control unit 9 ensures that the image data calculation unit 6, the image data analysis unit 7 and the comparison unit 8 cooperate according to the method described above using FIG. 1. For example, a starting compression factor SKF stored in the storage unit 4 can initially be provided to the image data calculation unit 6. After the first compression with this starting compression factor SKF, the compressed data D_{K} are related to the image data analysis unit 7 which then determines a quality value Q_{I} using a predetermined quality measure Q_{M} that, for example, can be provided via the terminal 10 and the terminal interface 3. This quality value Q_{I} is passed to the comparison unit 8, which compares this with a desired quality value Q_{S} that is likewise provided via the terminal 10 and the terminal interface 3. If the current quality value Q_{I} does not agree with the desired quality value Q_{S} within a provided measure, this is communicated to the control unit 9 which then prompts the image data calculation unit 6 to implement a new compression of the image data D_{B} with an altered compression factor KF.

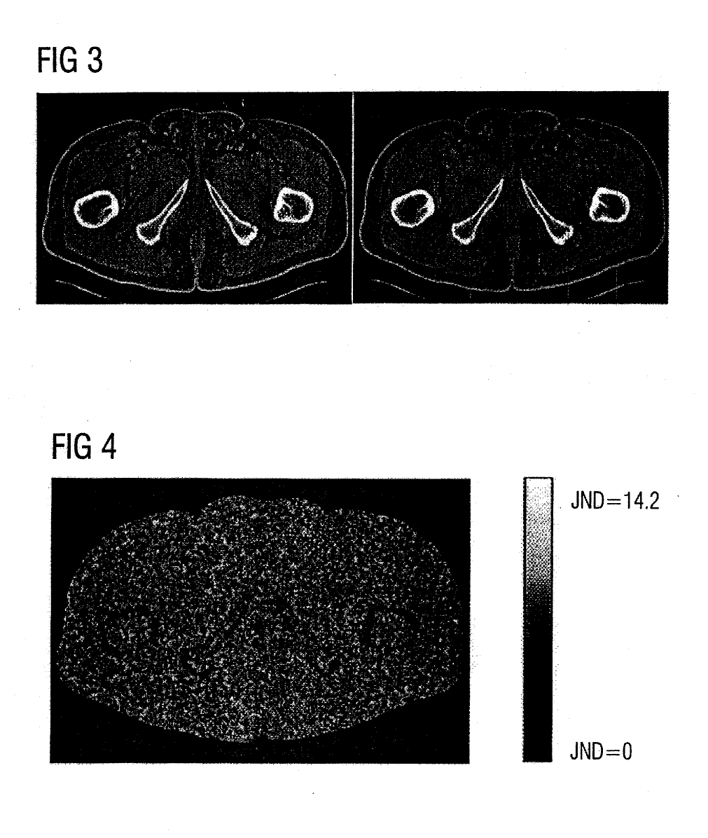

As explained above, images compressed particularly well can be generated with the inventive method using what is known as a JND map. For this a JND value is determined for each image point on the basis of the compressed image data and the uncompressed image data and these values are then plotted per pixel into a type of image. The function of such a JND map is subsequently explained using FIGS. 3 and 4.

FIG. 3 shows on the left side an axial section through an uncompressed three-dimensional CT volume through the abdomen of a patient. Clearly visible here in bright white are a part of the pelvic bone and the femurs. This image was compressed with a three-dimensional JPEG2000 algorithm with a compression factor of 75 in order to obtain the right image in FIG. 3. The signal-to-noise ratio or, respectively, the quality value Q_{SNR} is 45.9 dB here. The set of the compressed data thereby amounts to only 1/75 of the uncompressed data.

FIG. 4 shows the JND map belonging to FIG. 3. The JND value can be approximately read off at the adjoining grey value bar. The higher JND values which lie more in white indicate a higher compression error. It is clearly visible that a particularly high image quality with a relatively low JND value is achieved at the edges of the bones. The average JND value for the example in FIG. 4 is 5.9. The average JND value can be used, for example, in order to optimally set the global compression factor for the image. Specific quality values can also likewise be predetermined for specific regions using such a JND map.

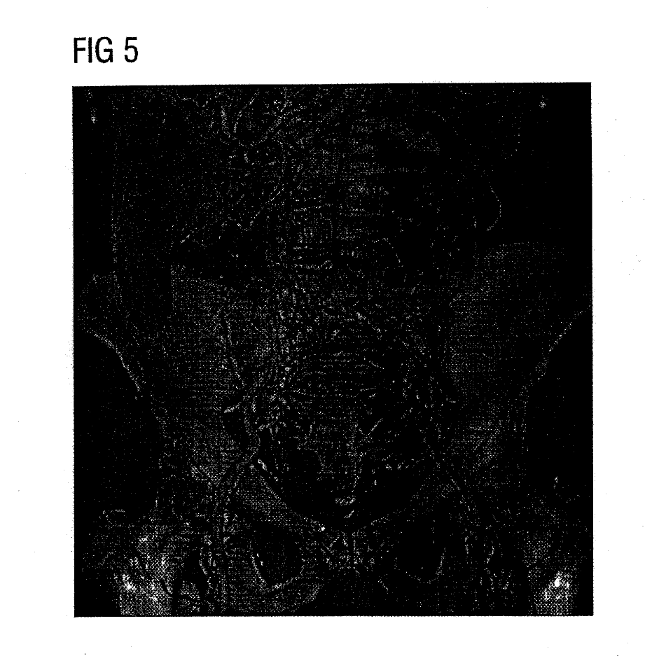

Various examples for uncompressed image data and image data compressed differently depending on location are shown in FIGS. 5 through 8.

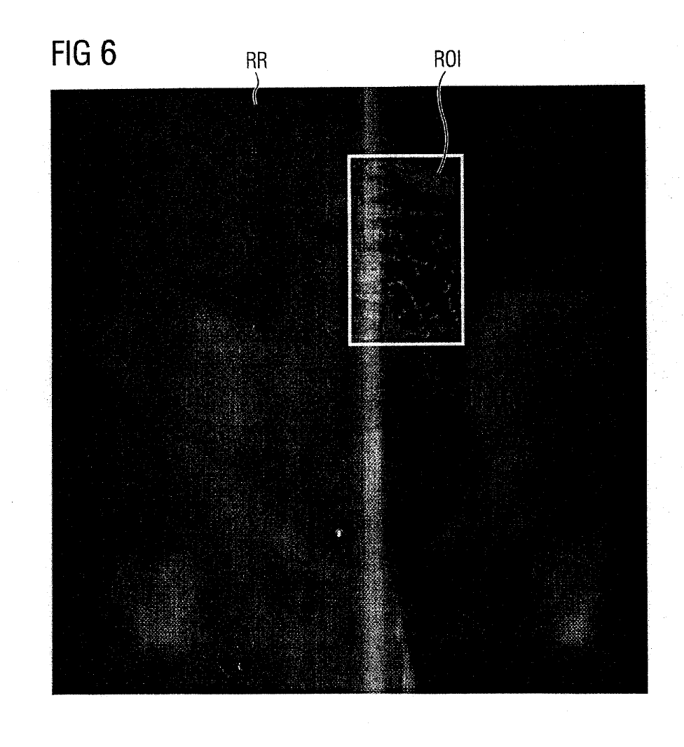

FIGS. 5 and 6 show images known as VRT Volume Rendering Technology or Volume Representation Technology) images, taken longitudinally through a human abdomen in which the pelvis as well as the blood vessels are shown “three-dimensionally” or “perspectively”. FIG. 5 is an uncompressed image with a high quality with an average SNR value of 45 dB. For comparison, FIG. 6 shows the same image in which only a specific region of interest ROI that shows a specific detail (here an aneurysm of the aorta) is stored with the original high quality. In contrast to this, the remaining image regions RR in FIG. 6 are stored with a significantly lower quality of 18 dB. This image requires a significantly smaller storage space (namely only 16 kBytes) for storage of this image, in comparison to 500 kBytes for the original image according to FIG. 5.

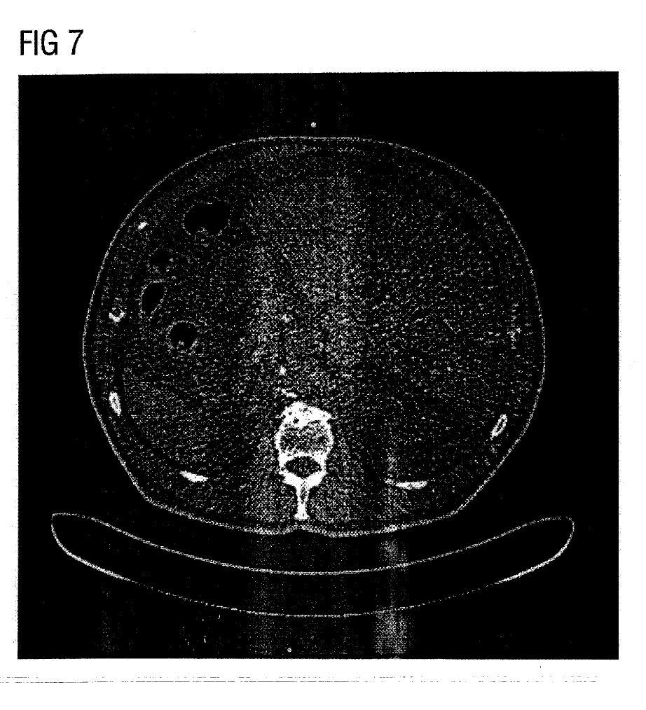

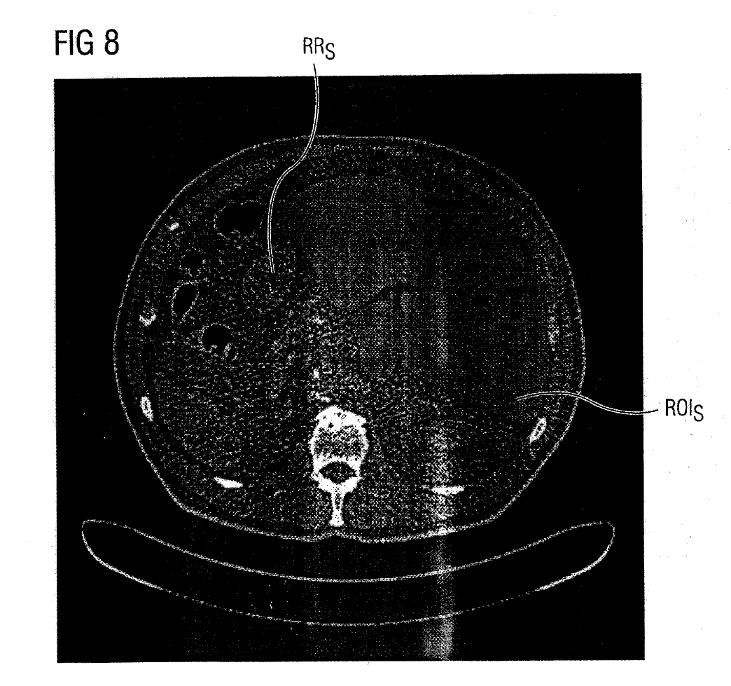

FIG. 7 shows a two-dimensional axial image through the abdominal region of a patient. This image is compressed with a very low quality level; here the signal-to-noise interval (i.e. the SNR quality value Q_{SNR}) is only 22 dB. FIG. 8 shows as an alternative an image compressed according to the inventive method, wherein a specific region of interest ROIs (here exactly the part that shows the liver of the patient) was locally compressed only so much that there a higher quality Q_{SNR}=45 dB exists, in contrast to which the remaining region RR_{S} is stored with the low quality of 22 dB. Here the region of interest ROIs in which the liver was selected in the image by means of an automatic segmentation method was thereby automatically determined here. This image thus allows an exact diagnosis of the state of the liver (which is what this exposure is ultimately about), with the remaining regions of the image having been stored with poorer quality, however for this purpose with a high compression factor in order to reduce the data quantity as much as possible.

In the aforementioned images the calculation of the SNR quality values Q_{SNR} respectively occurred with the equation (1).

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for compressing image data comprising the steps of:
compressing image data using a lossy compression method with a predetermined starting compression factor, thereby obtaining compressed data;
automatically electronically analyzing the compressed data to determine a quality value thereof relative to a defined quality measure;
determining a desired quality value based on said defined quality measure, and automatically electronically comparing said quality value with said desired quality value, thereby obtaining a comparison result; and
implementing a new compression of said image data or a further compression of said compressed data, using at least one of a different compression factor and a different compression method, when said comparison result indicates that said quality value deviates from said desired quality value by a predetermined amount.

2. A method as claimed in claim 1 comprising automatically electronically globally defining at least one of said quality measure and said quality value for an entirety of an image represented by said image data.

3. A method as claimed in claim 1 comprising automatically electronically defining at least one of said quality measure and said quality value individually for selected local regions of an overall image represented by said image data.

4. A method as claimed in claim 3 comprising, for at least some of said local image regions, defining at least one of a different local quality measure and a different local quality value.

5. A method as claimed in claim 3 comprising defining said local image regions by implementing a segmentation method on said image data.

6. A method as claimed in claim 1 wherein the step of analyzing the compressed data comprises analyzing the compressed data for a totality of an image represented by said image data to generate a quality value map dependent on said quality value, and wherein the step of comparing said quality value with said desired quality value comprises generating a desired quality value map of said total image dependent on said desired quality value, and automatically comparing said quality value map with said desired quality value map.

7. A method as claimed in claim 1 comprising employing a signal-to-noise ratio of said image data as said quality measure.

8. A method as claimed in claim 1 comprising defining said quality measure relative to a psychological criterion of human visual perception.

9. A method as claimed in claim 8 comprising defining said quality measure relative to a differential perceptibility threshold.

10. A method as claimed in claim 1 comprising compressing said image data by applying respectively different starting compression factors for different regions of an overall image represented by said image data.

11. A method as claimed in claim 1 comprising generating a compressed image as a result of the new compression of the image data or the further compression of the compressed data, and electronically linking compression information with said compressed image identifying each compression method and each compression method and each compression factor used to generate to said compressed image.

12. A device for compressing image data comprising:
an image data interface that receives image data;
a storage unit in which a plurality of compression factors, defined a defined quality measure, and a predetermined quality value are stored;
a compression unit in communication with said interface and said storage unit that compresses said image data using a lossy compression method with one of said compression factors as a starting compression factor, thereby obtaining compressed data;
an image analyzer in communication with said compression unit that analyzes the compressed data to determine a quality value thereof relative to said defined quality measure;
an image calculation unit in communication with said storage unit that predetermines a desired quality value based on said defined quality measure;
a comparator in communication with said image calculation unit that compares said quality value with said desired quality value, thereby obtaining a comparison result; and
said compression unit implementing a new compression of said image data or a further compression of said compressed data, using at least one of a different one of said compression factors and a different compression method, when said comparison result indicates that said quality value deviates from said desired quality value by a predetermined amount.

13. A device as claimed in claim 12 wherein said image calculation unit globally defines at least one of said quality measure and said quality value for an entirety of an image represented by said image data.

14. A device as claimed in claim 12 wherein said image calculation unit defines at least one of said quality measure and said quality value individually for selected local regions of an overall image represented by said image data.

15. A device as claimed in claim 14 wherein said image calculation unit, for at least some of said local image regions, defines at least one of a different local quality measure and a different local quality value.

16. A device as claimed in claim 14 wherein said image calculation unit defines said local image regions by implementing a segmentation method on said image data.

17. A device as claimed in claim 12 wherein said image analyzer analyzes the compressed data for a totality of an image represented by said image data to generate a quality value map dependent on said quality value, and generates a desired quality value map of said total image dependent on said desired quality value, and wherein said comparator compares said quality value map with said desired quality value map.

18. A device as claimed in claim 12 wherein said image calculation unit employs a signal-to-noise ratio of said image data as said quality measure.

19. A device as claimed in claim 12 wherein said image calculation unit defines said quality measure relative to a psychological criterion of human visual perception.

20. A device as claimed in claim 19 wherein said image calculation unit defines said quality measure relative to a differential perceptibility threshold.

21. A device as claimed in claim 12 wherein said compression unit compresses said image data by applying respectively different starting compression factors for different regions of an overall image represented by said image data.

22. A device as claimed in claim 12 wherein said compression unit generates a compressed image as a result of the new compression of the image data or the further compression of the compressed data, and electronically links compression information with said compressed image identifying each compression method and each compression method and each compression factor used to generate to said compressed image.

23. A computer-readable medium encoded with a data structure and loadable into a processor supplied with image data, said data structure causing said processor to:
compress said image data using a lossy compression method with a predetermined starting compression factor, thereby obtaining compressed data;
automatically analyze the compressed data to determine a quality value thereof relative to a defined quality measure;
determine a desired quality value based on said defined quality measure, and automatically electronically comparing said quality value with said desired quality value, thereby obtaining a comparison result; and
implement a new compression of said image data or a further compression of said compressed data, using at least one of a different compression factor and a different compression method, when said comparison result indicates that said quality value deviates from said desired quality value by a predetermined amount.
